(19) United States
(12) Patent Application Publication
(10) Pub. No.: US 2023/0206147 A1
(43) Pub. Date: Jun. 29, 2023

(54) IMPROVED EMPLOYEE SCHEDULE FORECASTING

(71) Applicant: SOHAM INC, Bellevue, WA (US)

(72) Inventors: Srinivas Kasy AIYAR, Kent, WA (US); Kiran Kumar GURUMUKHl, Bellevue, WA (US)

(21) Appl. No.: 17/802,906

(22) PCT Filed: Feb. 26, 2021
(86) PCT No.: PCT/US21/20042

§ 371 Date: Aug. 26, 2022

Related U.S. Application Data
(60) Provisional application No. 62/981,806, filed on Feb. 26, 2020.

(51) Int. Cl. G06Q 10/0631; G06Q 10/04

(52) U.S. Cl. CPC G06Q 10/063116; G06Q 10/063114; G06Q 10/04

(57) ABSTRACT

Systems and methods are described for generating, employee schedules to satisfy appointments in which, information is received indicative of: a number of booked appointment minutes and a count of booked appointments; a number of scheduled employee minutes and a count of scheduled employees; and a number of employee break minutes. Based on a forecasting model applied to the received information, a first forecast of future appointment minutes may be determined. One or more weights may be determined for the first forecast based on performance of the first forecast against history of booked appointment minutes. Based on the first forecast and the respective weights, a schedule indicating a number of employees needed to satisfy the forecast of future appointment minutes may be generated.

### CROSS REFERENCE TO RELATED APPLICATIONS

This application claims priority to and the benefit of U.S. Provisional Patent Application No. 62/981,806, filed Feb. 26, 2020, the disclosure of which is incorporated herein by reference in its entirety for any and all purposes.

### BACKGROUND

Employee scheduling impacts the profitability of many service-related businesses, including, for example spas, salons, med spas, fitness centers, pet services, resort spas, and car services. Such businesses often must use intuition to manually craft employee schedules well in advance. This process can be onerous and inefficient.

### SUMMARY

Systems and methods are described herein for generating a schedule of employees needed to satisfy one or more appointments. According to the systems and methods, information may be received that is indicative of: a number of booked appointment minutes and a count of booked appointments; a number of scheduled employee minutes and a count of scheduled employees; and a number of employee break minutes. Based on a forecasting model applied to the received information, a first forecast of future appointment minutes may be determined. One or more weights may be determined for the first forecast based on a performance of the first forecast against a history of booked appointment minutes. Based on the first forecast and the one or more weights, a schedule indicating a number of employees needed to satisfy the forecast of future appointment minutes may be generated. A second forecast of future available employee minutes may also be generated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 is a flow chart of an exemplary method for generating an employee schedule based on forecasts, in accordance with one aspect.

FIG. 2 is a diagram illustrating an example appointment book for a given day and example Center, in accordance with one aspect.

FIG. 3 is a diagram illustrating an example of the data that may be received/extracted for hourly time periods for a given day for a job in accordance with one aspect.

FIG. 4 is a diagram illustrating the determination of raw forecasts in accordance with one aspect.

FIG. 5 is a diagram illustrating an example of forecasted appointment minutes and forecasted employee minutes on a given date in accordance with one aspect.

FIG. 6 illustrates an exemplary method of detecting anomalies in advance booking data in accordance with one aspect.

FIG. 7 is a diagram illustrating an example of input data on which anomaly detection may be performed in accordance with one aspect.

FIG. 8 is a diagram illustrating an example of detected anomalies and an associated anomaly score for each anomaly in accordance with one aspect.

FIG. 9 illustrates a method of combining various utilization metrics into a target utilization in accordance with one aspect.

FIG. 10 is a diagram illustrating an ideal target utilization as a function of a number of service providers in accordance with one aspect.

FIG. 11 is a diagram illustrating an hourly time series forecast in accordance with one aspect.

FIG. 12 is a diagram illustrating a unit function f₁ in accordance with one aspect.

FIG. 13 is a diagram illustrating a unit function f₂ in accordance with one aspect.

FIG. 14 is a diagram illustrating a unit function f₃ in accordance with one aspect.

FIG. 15 is a diagram illustrating a unit function f₄ in accordance with one aspect.

FIG. 16 is a diagram illustrating a shift corrected unit function in accordance with one aspect.

FIG. 17 is a diagram illustrating a shift corrected unit function f₂′ in accordance with one aspect.

FIG. 18 is a diagram illustrating a shift corrected unit function f₃′ in accordance with one aspect.

FIG. 19 is a diagram illustrating a shift corrected unit function in accordance with one aspect.

FIG. 20 is a diagram illustrating an exemplary shift smoothed forecast in accordance with one aspect.

FIG. 21 is a diagram illustrating an exemplary shift visualization dashboard in accordance with one aspect.

FIG. 22 is a diagram of an exemplary dashboard illustrating an example forecasted daily schedule in accordance with one aspect.

FIG. 23 shows a diagram of an exemplary dashboard overlaying actual values in the past against forecasted values in accordance with one aspect.

FIG. 24 is a diagram of an exemplary dashboard illustrating an anomaly adjusted forecast in accordance with one aspect.

FIG. 25 is a diagram of an exemplary dashboard illustrating utilization for multiple Centers generating forecasts in accordance with one aspect.

FIG. 26 is a diagram of an exemplary dashboard illustrating an example of revenue gain visualization in accordance with one aspect.

FIG. 27 is a flow chart of an exemplary method in accordance with one aspect.

FIG. 28 is a block diagram of a system environment in accordance with one aspect.

### DETAILED DESCRIPTION

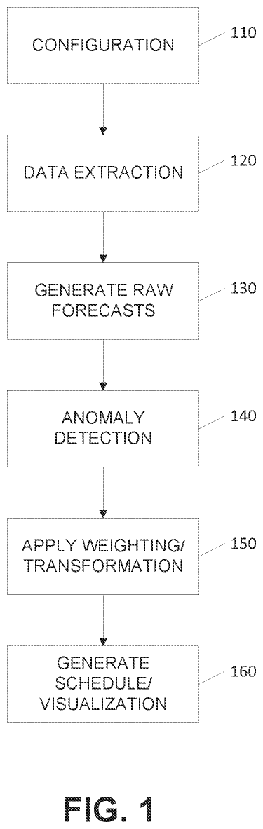

FIG. 1 provides an overview of one example of a method 100 of generating an employee schedule based on forecasts. As shown, the method may comprise the following steps—configuration 110, data extraction 120, generation of raw forecasts 130, anomaly detection 140, weighting/transformation 150, and schedule generation/visualization 160. Each step is described in greater detail below.

### Configuration

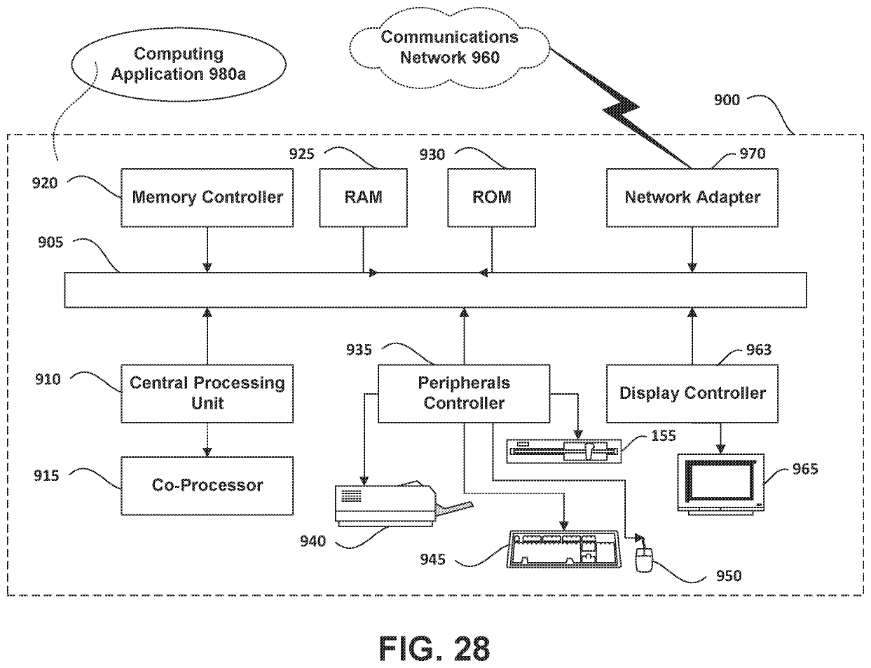

In the configuration step 110, a determination may be made by a computing device as to which jobs need forecasts. The computing device may comprise, for example, the computing device 900 of FIG. 28. A job may also be referred to herein as a task, a service, or the like. A job may be associated with an appointment, such as an appointment made by a customer (e.g., an individual, a user) to receive the services or work associated with a particular job, task, or service.

In businesses such as spas and salon, there typically are jobs or tasks provided by service providers who may perform a variety of services within a given establishment, which may be referred to herein as a given “Center.” An example of a job may be Hair Stylist at say, an establishment in Dallas, Tex., which may be called the “Dallas Center.” Jobs can also be combined, if desired, to treat as a single unit, say for example Lead Massage Therapist and Massage Therapists into All Massage Therapists.

In the configuration phase, seasonality inherent in appointments data may also be determined by a computing device analyzing it using spectral decomposition and auto-correlation functions.

A training start date may be assessed using the minimum dates when data for a given job is available. The number of days to forecast in future, preferred target utilization and physical limits, based on customer's use cases, may also set in this phase.

These are stored for future use as configuration parameters. The configuration parameters may comprise, for example:
1. Jobs (Hair Stylists, Nail Technicians, Massage Therapists, etc.)
2. Inherent Seasonalities (weekly, monthly, yearly, etc.)
3. Training Start Date (3 years in the past or recent)
4. Days to Forecast (for example, next 4 weeks)
5. Target Utilization (for example, 80%)
6. Physical Limits (max number of chairs, employees, center working days and hours).

### Data Extraction

In the next step 120, information, or data, may be received, or extracted, by a computing device, for use in the forecast generation step 130 (described below). For each configured job in a Center, the following data may be received/extracted at hourly granularity for each day, starting from the training start date until a time in the future (e.g., for advance bookings), such as one week, one month, two months, or three months in the future, for example. The received/extracted data may comprise at least a number of booked appointment minutes and a count of booked appointments, a number of scheduled employee minutes and a count of scheduled employees, and a number of employee break minutes. In addition to these types of information/data, other information/data may also be received, including one or more of the additional types of data/information listed in the following Table 1:

TABLE 1

| Index | Attribute | Description |
|---|---|---|
| 1. | Time Period | Time period for extracted data |
| 2. | Account | Name of the customer |
| 3. | Center | Name of the center |
| 4. | Job | Employee job such as Hair Stylist |
| 5. | Appointment | Total service minutes in time period |
| | Minutes | |
| 6. | Appointment Count | Maximum services happening in parallel |
| | | in time period |
| 7. | Scheduled Minutes | Total employee scheduled minutes in time |
| | | period |
| 8. | Scheduled | Maximum number of employees |
| | Employee Count | scheduled in time period |
| 9. | Break Minutes | Total break minutes in time period. Breaks |
| | | denote non-serviceable hours for an |
| | | employee such as lunch or meeting. |
| 10. | Advance Booking | The booked service minutes in future. |
| | Minutes (7, 14 and | These are advance bookings made by |
| | 21 days ahead) | customers. |
| 11. | Turnaway Minutes | Total service minutes that were turned away |
| | | due to non-availability of staff |
| 12. | Walk-in Minutes | Total service minutes of those booked less |
| | | than 3 hours before start of the service |
| 13. | Revenue | Total revenue from services performed in the |
| | | time period |
| 14. | Weather Data | Temperature and precipitation in the time |
| | | period |
| 15. | Holidays and Center | If the day is a center holiday and whether |
| | Working Hours | time period falls under working hours of |
| | | the center |

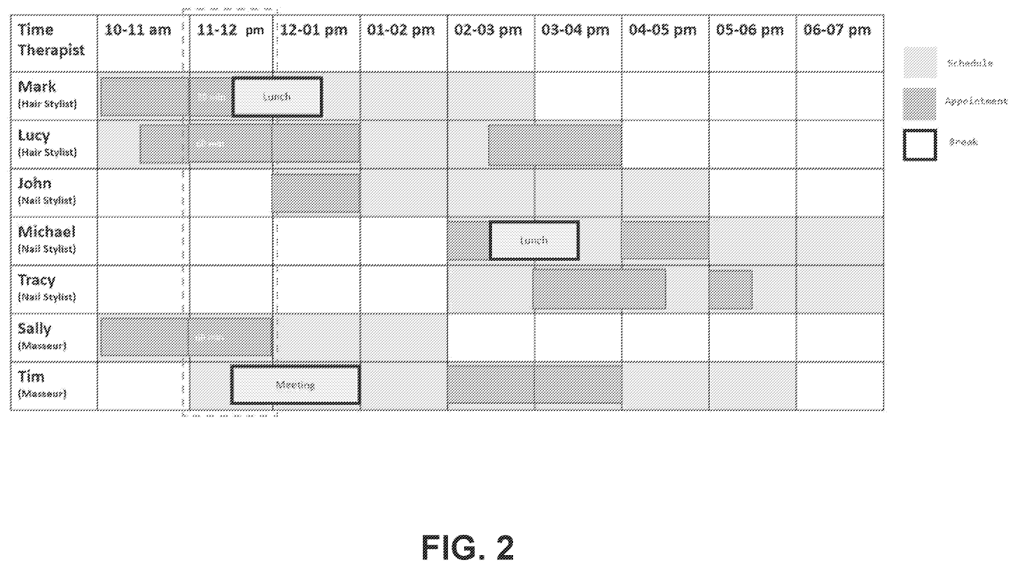

FIG. 2 shows an example appointment book for an example day at an example Center. By way of example and not limitation, consider an hour of time period (e.g., 11:00 AM-12:00 PM) in the day. For this example, the following data may be received/extracted by a computing device:
Appointment Minutes—there exists a total of 90 minutes booked for Hair Stylist job and a total of 60 minutes booked for Masseur job.
Revenue from the appointments is apportioned likewise across each job for each hour.
Appointment Count—there is a maximum of 3 appointments being performed in parallel within the hour.
Scheduled Minutes—there are 4 stylists, Mark, Lucy, Sally and Tim scheduled between 11-12. This corresponds to a total of 120 minutes of scheduled time for Hair Stylists and a total of 120 minutes for Masseurs.
Employee Count—there are 4 employees scheduled during the hour.
Break Minutes—There are 30 minutes for Hair Stylist (Lunch for Mark) and 30 minutes for Masseur (Meeting for Tim). Workable time is only 90 minutes for the Hair Stylist job even though 120 minutes of scheduled time exists.
Advance Booking Minutes—assume that the 30-minute appointment was booked 10 days ago, while the rest were booked on the same day as the day of appointment. The advance booking minutes in this case would be a total 30 minutes for the Hair Stylists job.
Walk-in Minutes—there are a total of 60 minutes for Hair Stylists and 60 minutes for Masseurs since both the appointments were created on the same day as the day of appointment.
Weather data may be made available via open application programming interfaces (APIs).

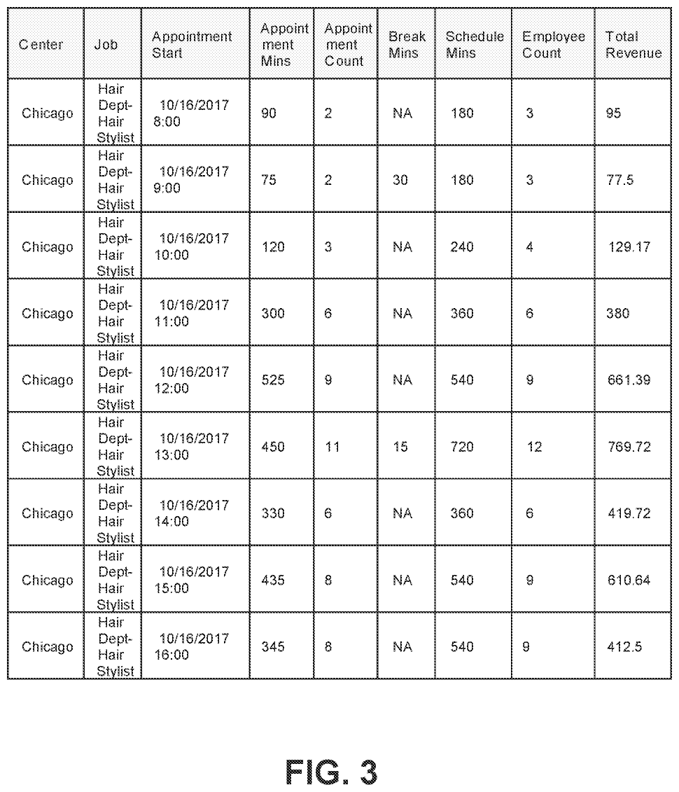

FIG. 3 shows an example of the data that may be received/extracted for each of the hourly time periods from 8:00 am to 16:00 pm on an example day (10/16/2017) for a Hair Stylist job at a Center called “Chicago.”

### Raw Forecasts

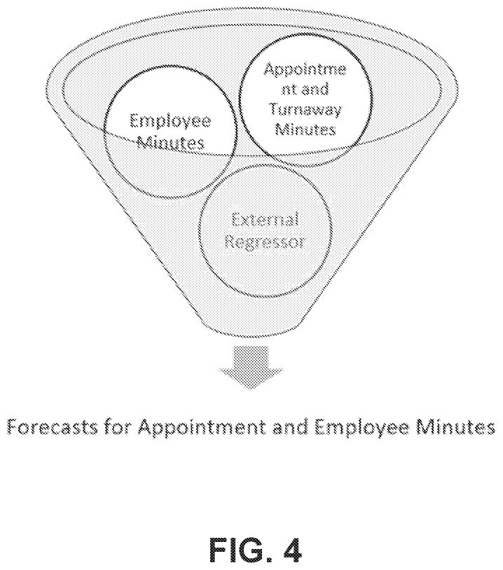

In step 130, one or more raw forecasts may be determined by a computing device based on the received data. For example, a forecast of future appointment minutes may be generated. Alternatively, or in addition, a forecast of future employee minutes may be generated. In accordance with one aspect, the one or more raw forecasts may be computed by a computing device on the following time series:
1. Appointment Minutes+Turnaway Minutes
2. Employee Minutes (Scheduled Minutes−Break Minutes)
3. External Regressors on Weather and Holidays
   FIG. 4 graphically illustrates the determination of the raw forecasts in step 130. As illustrated, based on a forecasting model applied to the extracted data, a first forecast of future appointment minutes and a second forecast of future available employee minutes may be determined. Note that adjustments may be made to handle empty values (e.g., “N/A” or “not available”) and missing values. For example, on a holiday, such as July 4^{th}, there may have been no appointments, and therefore, data for that day may be missing. In that case, a value of 0 may be inserted.

In accordance with one aspect, raw forecasts may be determined by a computing device using a Seasonal and Trend Decomposition using Loess forecast (STLF) model. Additionally, other forecasting models may be employed. In one example, the following R programming language code (also referred to herein as “R”) may be used to perform the time series forecasting:

```
library(forecast)
library(zoo)
library(lubridate)
library(stringr)
library(DescTools)
library(dplyr)
trainset <− msts(appts[1:periodstotrain], seasonal.periods = seasonality,
ts.frequency = freq)
fcastappts <− stlf(trainset,
    h=periodstoforecast,
    method=‘ets’,
    s.window=10,
    t.window=5,
    allow.multiplicative.trend=FALSE,
    level = c(10, 25, 50, 75, 95, 99))
trainset <− msts(emps[1:periodstotrain], seasonal.periods = seasonality,
ts.frequency = freq)
fcastemps <− stlf(trainset,
  h=periodstoforecast,
  method=‘ets’
  level = c(10, 25, 50, 75, 95, 99));
```

where:
appts=appointment minutes data
emps=employee minutes data
fcastappts=forecast for appointment minutes
fcastemps=forecast for employee minutes

Alternatively, or in addition, raw forecasts may be determined in part using a Vector Autoregression (VAR) model. For example, while the STLF model may be utilized to generate hourly forecasted minutes, the VAR model may generate daily forecasted minutes. The hourly forecasted minutes may then be adjusted to match the VAR output i.e., the daily forecasted minutes for a given day. The VAR model may be a multivariate forecasting algorithm used when two or more time series influence each other, is used with appointment booking minutes, employee schedule minutes and turnaway minutes as interdependent timeseries vectors. This is since a number of appointments are inherently affected by number of scheduled employees at the time, and along similar lines with turnaway appointments. The timeseries may be affected by other variables such as advance bookings and holidays. These are fed to the VAR model using the exogen parameter as in the following example programming language code:

```
vmodel <− VAR(apptsday[(1:daystrainperiod),c(2,3,4)], p = 7
    , type = “none”
    , season = 4
  , exogen = exogen
  , lag.max = 35, ic = “AIC”)
```

Additionally, other programming languages, tools, or environments may be used.

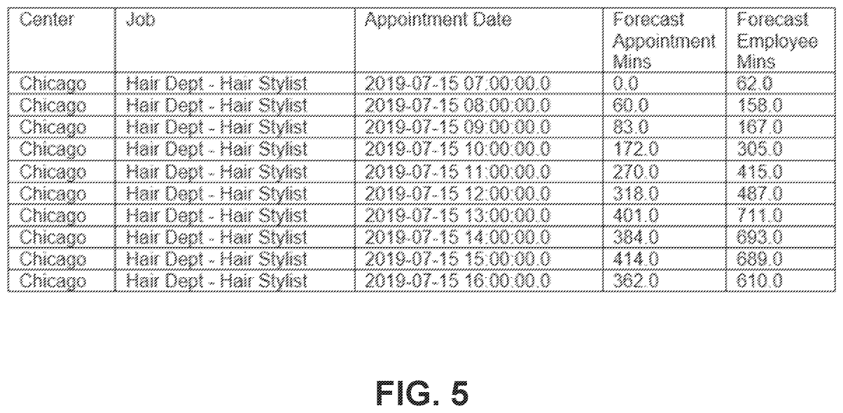

The forecasts may be computed, by a computing device, every week to provide 28-day, 21-day, 14-day and 7-day forecasts. As an example, a 28-day forecast may be defined as one that gets generated 28 days before. FIG. 5 shows an example of forecasted appointment minutes and forecasted employee minutes on a given appointment date (e.g., 07-15-2019) for each hourly interval from 7:00 am to 16:00 pm.

Along with mean forecast values, 10%, 25%, 50%, 75% and 95% confidence intervals may also be computed by a computing device and stored.

### Anomaly Detection

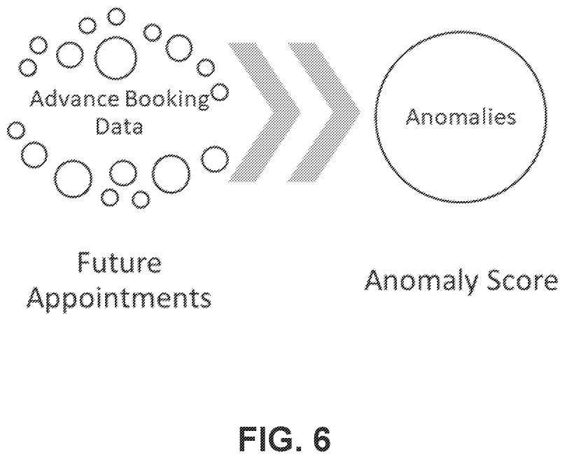

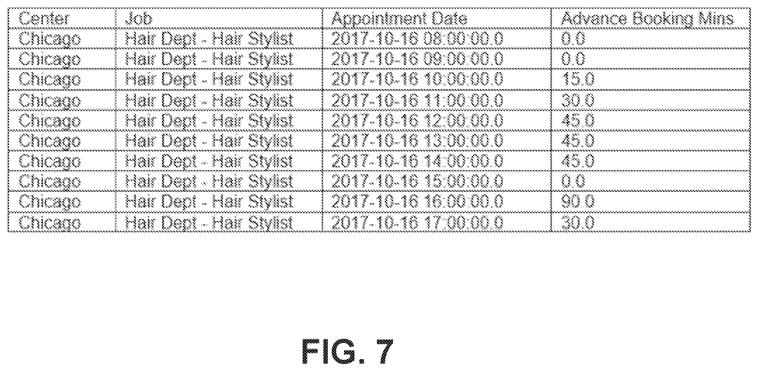

In step 140, anomaly detection methods may be performed by the computing device on the received/extracted advance booking data to determine outliers in future bookings. Anomalies may be a good indicator of a variety of factors that may affect the need for more employees to be scheduled, such as heightened guest (e.g., an individual, a user) activity, for example due to holidays, events of conferences in a city, or campaigns run by the Center, for example. FIG. 6 illustrates the method of detecting anomalies in advance booking data. FIG. 7 shows an example of input data on which anomaly detection may be performed.

In general, the anomaly detection method works by detecting outlier values in advance booking data aggregated over a day. The detection method provides days where an anomaly might exist and the associated deviation. Based on how far the deviation is from usual observed values, an anomaly score is computed for example by a computing device. The anomaly score may provide an indication of how significant is the anomaly. For example, an anomaly value or score of <1 may mean a negative anomaly, a score or value of >1 may mean a positive anomaly, and a score=1 may indicate no anomaly.

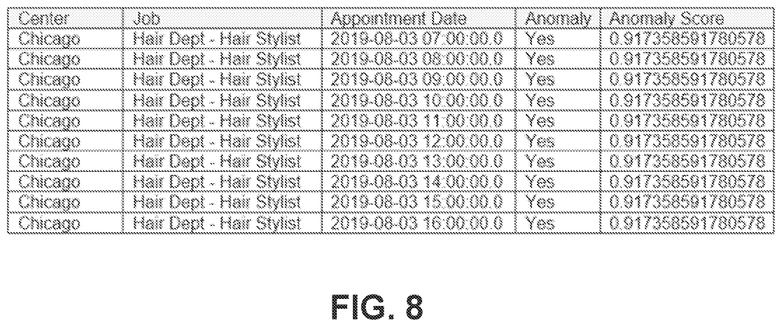

FIG. 8 shows an example of detected anomalies and an associated anomaly score for each anomaly.

In accordance with one aspect, the following R programming language code may be used to implement, by a computing device, the anomaly detection method:

```
library(tibbletime))
library(anomalize))
anomalydata7 <− data.frame(
  appointmentstartdate7 =
    ts$data$appointmentstartdate[ts$data$appointmentstartdate <
    startdate7 &
              ts$data$appointmentstartdate >= initialdate],
  advancebookingmins7day =
      ts$data$advancebookingmins7day[ts$data$appointmentstartdate <
    startdate7 &
                ts$data$appointmentstartdate >=
initialdate]) %>%
  group by(date = date(appointmentstartdate7)) %>%
  summarise(mins = sum(advancebookingmins7day))
anomaly7 <− (anomalydata7 %>% as_tbl_time(index = date)
        %>% time_decompose(mins, method = “stl”, merge = TRUE)
        %>% anomalize(remainder, alpha = 0.1, method = “gesd”)
        %>% time_recompose( ))
for (dt in anomaly7$date[anomaly7$anomaly == ‘Yes’ &
          anomaly7$date >= startdate &
          anomaly7$date < startdate7]) {
    cond <− (as_date(forecast$time) == as_date(dt))
    cond2 <− (anomaly7$anomaly == ‘Yes’ & anomaly7$date == dt)
    forecast$data$anomaly7[cond] <−
    ifelse(anomaly7$observed[cond2] <
            anomaly7$recomposed_l1[cond2],
    anomaly7$observed[cond2]/anomaly7$recomposed_l1[cond2],
    anomaly7$observed[cond2]/anomaly7$recomposed_l2[cond2])
}
```

As an example, consider an analysis of an appointment book 7 days before a given day of appointments. As illustrated in Table 2, a given Center may usually see, on an average, around 300 appointment minutes booked in advance. However, if on a given day, the Center sees almost 900 minutes of booking, possibly due to a conference in the city, this would be flagged by the anomaly detection process described herein as an anomaly, along with a score of 3 indicating positive anomaly.

TABLE 2

| | Booked | | |
|---|---|---|---|
| | Appointments | | Anomaly |
| Day | 7 day ahead | Anomaly | Score |
| Apr. 1^{st}, 2019 | 310 | No | — |
| Apr. 2^{nd}, 2019 | 290 | No | — |
| Apr. 3^{rd}, 2019 | 900 | Yes | 3 |
| Apr. 4^{th}, 2019 | 300 | No | — |

Based on the anomaly score value, the appointment minutes forecast may be adjusted to be the mean or a 10, 25, 75, or 90 percent confidence level.

The following Table 3 shows the adjustment to a forecast confidence level based on the detected anomaly score:

TABLE 3

| Anomaly Score | Mapped Forecast Confidence Level |
|---|---|
| Less than −8 | Lower 75% |
| Between −8 and −4 | Lower 50% |
| Between −4 and −2 | Lower 25% |
| Between −2 and 0 | Lower 10% |
| Between 0 and 1.1 | Forecast Mean |
| Between 1.1 and 2 | Upper 10% |
| Between 2 and 4 | Upper 25% |
| Between 4 and 8 | Upper 50% |
| Greater than 8 | Upper 75% |

### Weighting/Transformation

In step 150, one or more weights may be determined, by a computing device, for each of the first (future appointment minutes) and second (available employee minutes) forecasts based, at least in part, on a performance of the forecasts against a history of actual appointment and employee minutes. In case guest turnaway data is available, the appointment minutes and turnaway minutes are both added to the time series before feeding it to the forecast method. This may ensure the appointment forecast considers guest turnaway also and not just booked appointments.

Weights for the raw forecasts may be determined, by a computing device, based on one or more of the following factors:
1. Detected Anomalies
2. Target Utilization
3. Revenue Gain Adjustment
4. Minutes to Number of Employees
5. Smoothing (shift based)
6. Holidays and Work Timings
7. Weather Data

Each of these factors may play an important role in providing a better accuracy as well as usability on the final recommended employee schedule numbers.

### Weather Data

Weather information, such as temperature and rain, do affect the walk-ins in a center. For example, a snowstorm would result in fewer walk-in appointments in the day. In contrast, sunny weather might increase number of Brazilian waxing appointments when people decide to go to the beach.

Table 4 provides an example of how temperature might seem to be co-related to appointments:

TABLE 4

| Day | Temperature (in C.) | Appointment Minutes |
|---|---|---|
| Apr. 1^{st}, 2019 | 20 | 1080 |
| Apr. 2^{nd}, 2019 | 19 | 1100 |
| Apr. 3^{rd}, 2019 | 10 | 820 |
| Apr. 4^{th}, 2019 | 18 | 950 |
| Apr. 5^{th}, 2019 | 22 | 1200 |
| Apr. 6^{th}, 2019 | 21 | 1050 |

### Target Utilization

As one example, target utilization may be determined as follows. There may be two measures of employee utilization:
1. Count based=#Appointments/#Scheduled Employees
2. Time based=#Appointment Minutes/#Scheduled Minutes

The appointment minutes forecast may be adjusted to achieve a target utilization level that is desired. Arriving at a good target utilization is dependent on multiple factors including:
1. Compensation model
2. Service pricing
3. Service duration
4. Guest arrival times
5. Guest turn-away
6. Other factors such as day of week

Typically, a target utilization of 100% based on count may be assumed given lack of preference by a user. The following R programming language code, which applies a linear translation, may be used to adjust a forecast based on target utilization:

Target Utilizationₜᵢₘₑ=Utilization Actualₜᵢₘₑ/Utilization Actual_{count}
where
Target Utilizationₕₒᵤᵣ=Utilization to target in the forecast for 100% count-based utilization
Utilization Actualₜᵢₘₑ=Actual utilization based on time
Utilization Actual_{count}=Actual utilization based on count

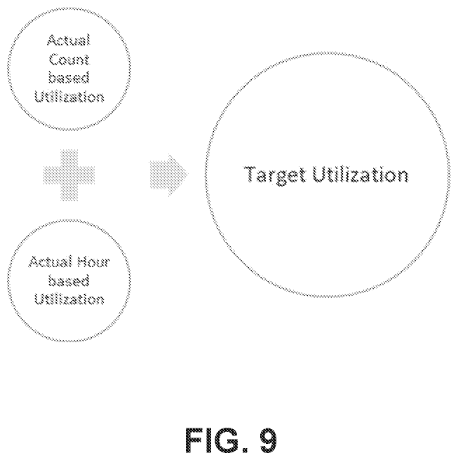

FIG. 9 illustrates a method of combining various utilization metrics into a target utilization.

As illustrated by the example in Table 5, assume a center has the following data collected for a few hours:

TABLE 5

| | | | | | | Utilization |
|---|---|---|---|---|---|---|
| | Appointment | Scheduled | Utilization | Appointment | Employee | (count |
| Hour | Minutes | Minutes | (time based) | Count | Count | based) |
| 10 am | 120 | 180 | 120/180 = 0.67 | 3 | 3 | 1.0 |
| 11 am | 180 | 240 | 180/240 = 0.75 | 4 | 4 | 1.0 |
| 12 pm | 90 | 240 | 90/240 = 0.38 | 2 | 4 | 0.5 |

The Average Utilization (time based) may be determined as follows:

Average Utilization(time based)=(0.67+0.75+0.38)/3=0.6.

The Average Utilization (count based) may be determined as follows:

Average Utilization(count based)=(1.0+1.0+0.5)/3=0.8.

To arrive at a target utilization to be used with the forecast, a Target Utilization value may be determined as:

Target Utilization=0.6/0.8=0.75.

This time-based utilization should result in a 100% count-based utilization, which would mean the forecasting method has provisioned for roughly 1 employee per appointment in the hour.

Alternatively, or in addition, the ideal target utilization may be arrived at using a Queuing theory model. The goal for targeting a utilization that is less than 100% is essentially to eliminate turnaways. The probability that a customer has to wait in queue for his or her turn is given by erlang C distribution as in the following example programming language code:

```
# Probability that a customer has to wait in queue (or probability of
turnaway)
# where c = number of service providers, p = utilization
erlangc <− function(c, p) {
  fir <− 1−p
  sec <− factorial(c)/(c*p)\hat{ }c
  thi <− 0
  for (i in 0:(c−1)) {
    thi <− thi + ((c*p)\hat{ }i)/factorial(i)
  }
  prob <− 1 + (fir * sec * thi)
  prob <− ifelse(prob == 0, 0, 1/prob)
  prob
}
# length of the queue is given by the following function
# with c = service providers, lamda = arrival rate and mue = service rate
calculatewq <− function(c,lambda,mue) {
  rho <− (lambda/mue)
  P0inv <− (rho\hat{ }c)/(factorial(c−1)*(c−rho))
  for (i in 0:(c−1)) {
    P0inv <− P0inv + ((rho\hat{ }i)/factorial(i))
  }
  P0 = 1/P0inv
  Lq = ((rho\hat{ }(c + 1))*P0)/(factorial(c−1)*((c−rho)\hat{ }2))
  Wq = Lq/lambda
  #Wq <− max(0, round(Wq))
  #Lq <− max(0, round(Lq))
  a <− cbind(Lq, Wq)
  return(a)
}
```

Once a computing device determines the probability using erlang C and length of the queue, the computing device may determine the target utilization that amounts to more than 50% probability of having a queue buildup of more than 1 by using the following example programming language code:

```
# get the optimal target utilization
turnawayprob <− 0.5
providers <− c(1,2,3,4,5,6,7,8,9,10,11,12,13,14,15,16,17,18)
ut <− (1:20)*.05
optutil <− NULL
for (s in providers) {
  util <− 1
  for (u in ut) {
    prob <− erlangc(s, u)
    lq <− calculatewq(s,arrivalrate,servicerate)[1]
    #print(paste0(“s=”,s,“,lq=”,lq))
    if (prob > turnawayprob ∥ lq > 1) {
      util <− u
      break
    }
  }
  optutil <− append(optutil, util)
}
plot(x = providers, y = optutil, type=‘l’, lwd = 2, xlab=“# Providers”,
ylab=“Utilization”)
```

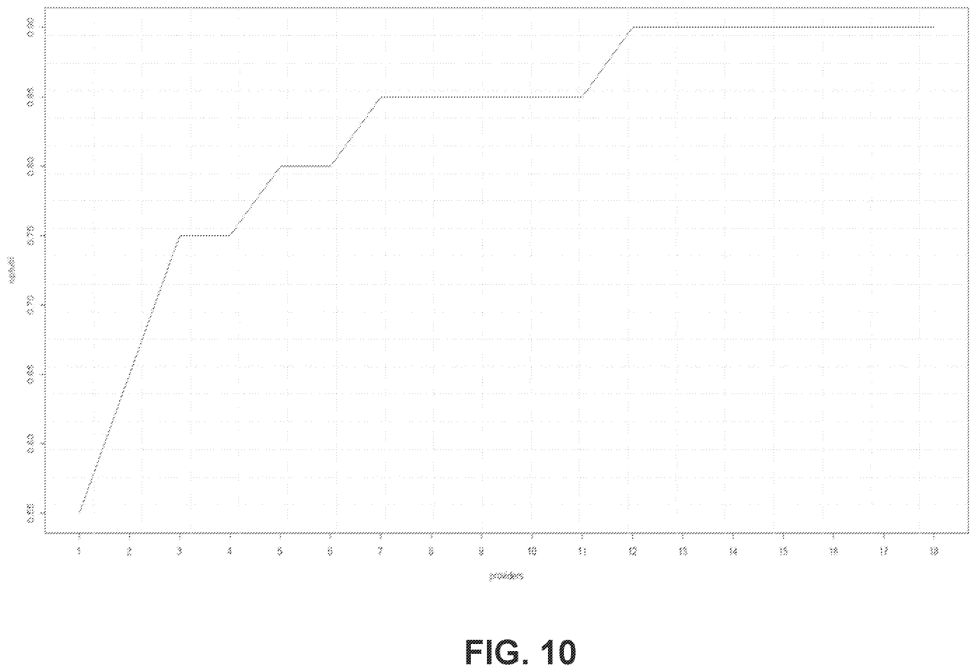

Referring to FIG. 10, an exemplary diagram illustrating an ideal target utilization as a function of the number of service providers is provided. In the example of FIG. 10, the x-axis indicates a number of services providers and the y-axis indicates an optimal utilization (also referred to herein as optutil). As an example, as shown in FIG. 10, an ideal target utilization may be determined, for example by a computing device, as 0.90 in an instance in which there are 12 to 18 service providers (e.g., scheduled employees). On the other hand, an ideal target utilization may be determined as 0.75 in an instance in which there are 3 service providers.

In accordance with one aspect, the forecasted minutes (e.g., forecasted appointment minutes and/or forecasted employee minutes) may be adjusted by a computing device using the following formula:

Forecast(adjusted)=[Forecasted Minutes]/[Target Utilization]
where the [Target Utilization] may be a function of [Forecasted Minutes], equivalent to number of service providers, as indicated above.

### Revenue Gain Adjustment

If data around employee hourly wages and service commissions is available, a better way to compute a target utilization is based on maximizing the gain when using the forecast. If forecasted employee values are lower, appointments may be lost due to non-availability while high values in forecast may cause many employees to sit idle. Both have implications on revenue. A utilization adjustment on forecast can be chosen, by a computing device, to maximize the gain so as to strike a balance. However, the gain adjustment can only be done on past data when actuals are available. Hence it should be noted that it may not be always accurate when used in the future.

Revenue Gain resulting from a Center following a generated forecast can be determined by a computing device against actual values in the past, as follows:
1. Lost Appointment Hours resulting from following the forecast (limited to walk-ins) may be determined as:
   LAH=IF [A]>[P] THEN MIN([A]−[P], [W]) ELSE 0 END
2. Saved Employee Hours (against actual set schedule) may be determined as:
   SEH=[E]−[P]
3. Saved Turnaways (when the generated forecast corrects under-provisioning) may be determined as:
   STH=IF [P]>[E] THEN SIGN([P]−[E])*MIN(ABS([P]−[E]), [T]) ELSE 0 END

These lost and saved hours can then be totaled and translated into a monetary value ($$) based off of a value for revenue per hour, as follows:

GAINi=(SEH*[$ Overhead per hr])−((LAH−STH)*(1−[Commission %])*[$ Revenue per Appointment Hour])
where
Gainᵢ=Gain at utilization i, such that 0<i<100
[$ Overhead per hr]=$ overhead on employees when not servicing any customer
[Commission %]=Commission paid to employees when servicing a customer
[$ Revenue per Appointment Hour]=Revenue from the service

The target utilization selected may then be the one that corresponds to the maximum gain across various utilization values, as follows:

Target Utilizationₜᵢₘₑ=MAX(Gainᵢ)

As illustrated by example in Table 6, consider the following forecast computed by a computing device at various values of target utilization i, and actual observed values in the same time period.

### Assume:

$ Overhead per hour=$15, while
$ Revenue per Appointment hour=$60
Commission %=0.5
Walk-in Minutes=Same as Appointment mins (all appointments are walk-ins)

TABLE 6

| | Assumed | | | | | | | | |
|---|---|---|---|---|---|---|---|---|---|
| | Target | Computed | Actual | Actual | Actual | | | | |
| | Utilization | Forecast | Appointment | Employee | Turnaway | | | | |
| Day | (i) | Mins (P) | Mins (A) | Mins (E) | Mins (T) | LAH | SEH | STH | Gain(i) |
| 1 | 0.5 | 400 | 300 | 240 | 30 | 0 | −160 | 30 | −25 |
| 1 | 0.6 | 333 | | | | 0 | −93 | 30 | −8.3 |
| 1 | 0.7 | 286 | | | | 14 | −46 | 30 | −3.5 |
| 1 | 0.8 | 250 | | | | 50 | −10 | 10 | −22.5 |
| 1 | 0.9 | 222 | | | | 78 | 18 | 0 | −34.5 |
| 1 | 1.0 | 200 | | | | 100 | 40 | 0 | −40 |

In this example, the Gain appears to be at a maximum at a target utilization=0.7. In this example, it may be assumed, then, that a target utilization of 0.7 gives the maximum gain in revenue even in when using the forecast in the future.

As indicated above, in one aspect, the forecasted minutes may be adjusted, by a computing device, based on the optimal utilization using the following formula:

Forecast(adjusted)=[Forecasted Minutes]/[Target Utilization]

### Smoothing (Shift Based)

A smoothing may be performed based on a number of hours in a shift. As used herein, a “shift” may denote the number of hours employees need to work contiguously once they arrive at work. Different businesses have different rules for a shift. Shift based smoothing considers this aspect and may work better than moving averages which tend to bring down the forecasted values.

In greater detail, employees typically are required to work for a minimum number of hours on a given day, arriving at designated times of the day and leaving as their shift ends. A better forecast may be achieved if this aspect of a business is considered. As an example, consider a case where a forecast suggests an additional employee is needed for a given service hour. If this requires the employee to just work for that hour and leave for the day, it is most likely something the business will not be able to adopt. Thus, it may be helpful to smooth the forecast to consider this aspect. Approaches such as a moving average or exponential smoothing may distort a forecast without properly considering shifts. Described herein is an improved method for shift-based smoothing.

Preconditions (e.g., predetermined criteria) for the improved method may include:

an hourly time series such as forecast being available;

a minimum number of hours in a shift defined by business or industry;

a maximum number of hours in a shift defined by business or industry; and

a maximum number of employees that can be scheduled, based on availability for the day.

The following example illustrates the improved method of shift-based smoothing.

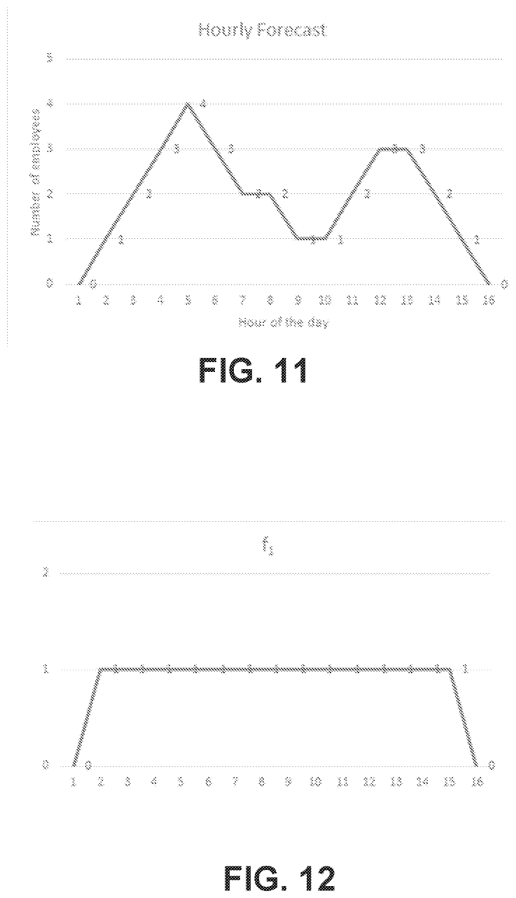

Consider an hourly time series forecast, such as the example hourly forecast depicted in FIG. 11. Assume that employees need to put in at least 4 hours and a maximum 10 hours in the day. Assume also the shift needs to be setup among a maximum of 6 employees that may be available in any given day.

The forecast itself may be imagined to be comprised of unit basis functions. The forecast F (e.g., FIG. 11) may be represented as:
F(t) where t=hour of the day, 0<=t<24

Let n be the max value of F(t). Next, consider the basis function, fᵢ as follows:

fᵢ(t)=if F(t)−i>=0 then 1 else 0 where 0<i<=n

The function F may thus be summarized as

F=f₁+f₂+f₃+. . . +fₙ

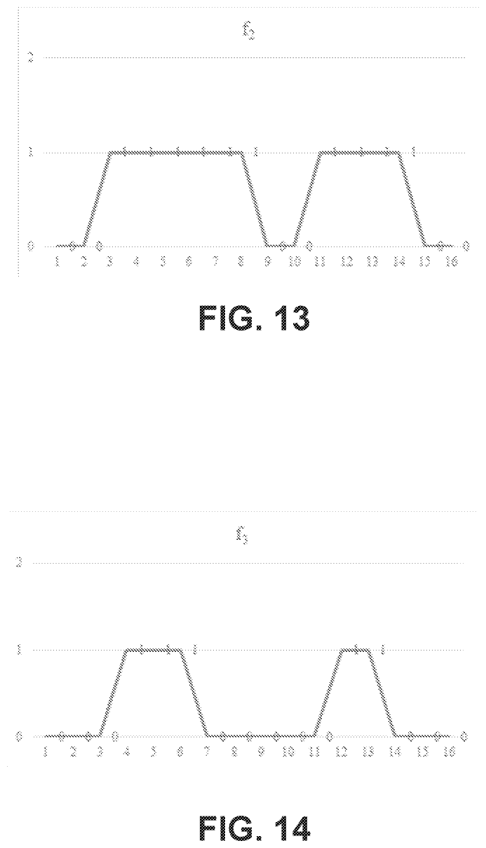

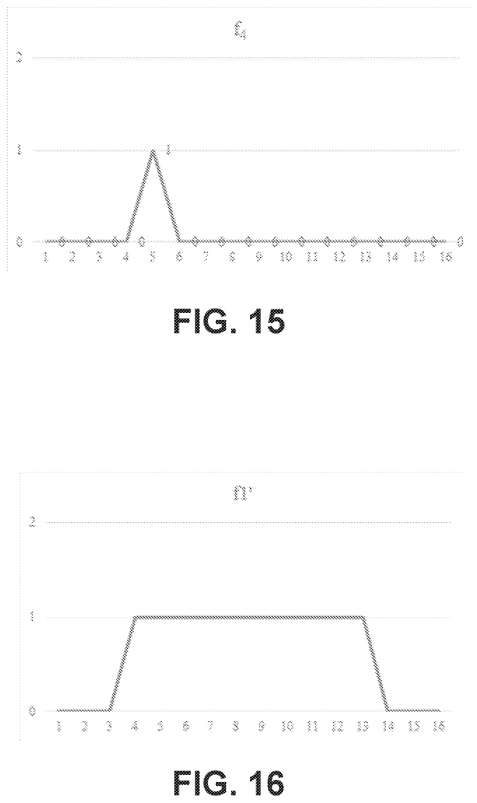

Each of the unit functions, fᵢ, represents an employee shift. Hence, the smoothed version of F needs to ensure all f satisfy the minimum and maximum hour rules. Diagrammatically the unit functions f₁, f₂, f₃, and f₄ be illustrated as shown in FIGS. 12, 13, 14, and 15. The following Table 7 provides a summary of the data:

TABLE 7

| t | F | f₁ | f₂ | f₃ | f₄ |
|---|---|---|---|---|---|
| 0 | 0 | 0 | 0 | 0 | 0 |
| 1 | 1 | 1 | 0 | 0 | 0 |
| 2 | 2 | 1 | 1 | 0 | 0 |
| 3 | 3 | 1 | 1 | 1 | 0 |
| 4 | 4 | 1 | 1 | 1 | 1 |
| 5 | 3 | 1 | 1 | 1 | 0 |
| 6 | 2 | 1 | 1 | 0 | 0 |
| 7 | 2 | 1 | 1 | 0 | 0 |
| 8 | 1 | 1 | 0 | 0 | 0 |
| 9 | 1 | 1 | 0 | 0 | 0 |
| 10 | 2 | 1 | 1 | 0 | 0 |
| 11 | 3 | 1 | 1 | 1 | 0 |
| 12 | 3 | 1 | 1 | 1 | 0 |
| 13 | 2 | 1 | 1 | 0 | 0 |
| 14 | 1 | 1 | 0 | 0 | 0 |
| 15 | 0 | 0 | 0 | 0 | 0 |

As shown, in this example, f₁ does not satisfy the condition for maximum hours in a shift while f₃ and fₜ do not satisfy the condition for minimum of 4 hours in a shift. f₂ and f₃ also contain two shifts rather than one since they are not continuous. These correspond to two employees. Both the shifts for f₃ do not satisfy the minimum 4 hours criteria.

Each of the above unit functions may be corrected, for example by a computing device, individually so that:
1. Each of them honor the minimum shift duration criteria. This can be achieved by either adding or removing data points from the series;
2. Adding or removing data points so that maximum employees are within specified limits; and
3. Adjusting fᵢ such that forecast F is matched as closely as possible.

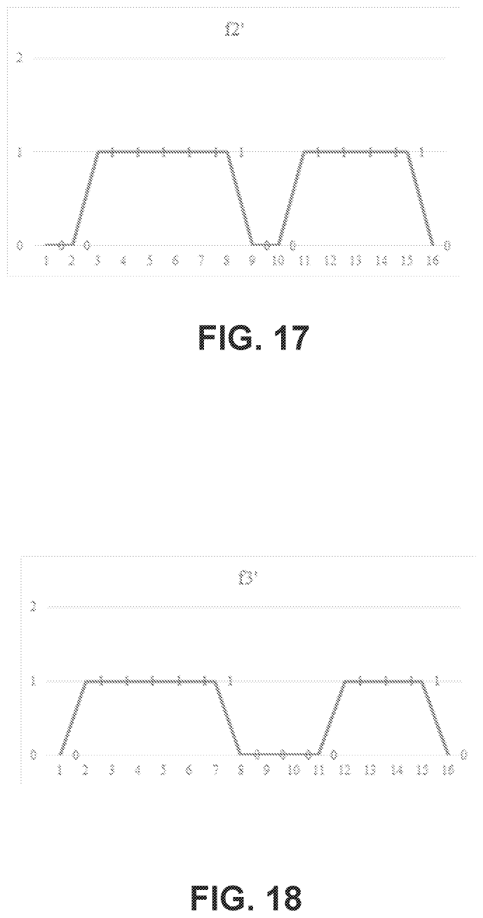

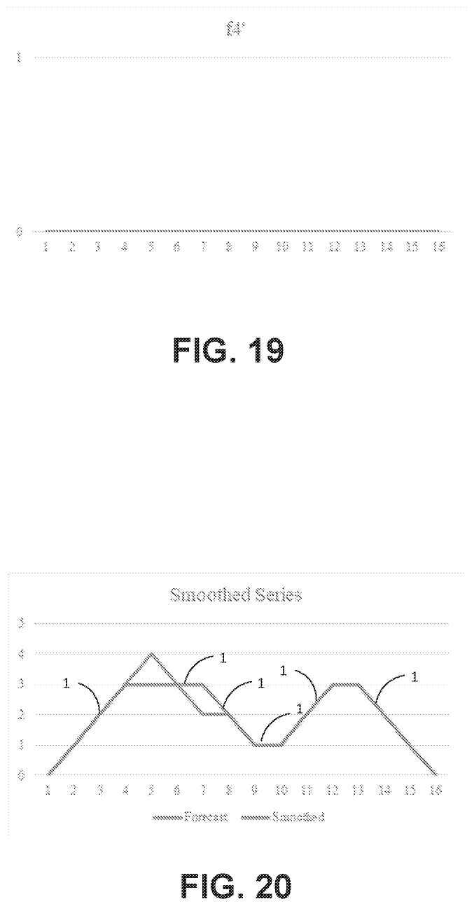

The shift corrected unit functions are illustrated in FIGS. 16, 17, 18, and 19.

The shift smoothed forecast may be produced by combining the shift corrected unit functions, as shown in FIG. 20. In this example, in the resulting smoothed forecast, there are 5 employees that map to the shifts—one in f₁, two in f₂, two in f₃ and zero in f₄. Each of the shifts honors the rule for minimum and maximum work hours in a day.

In accordance with one aspect, the library smooth in R may be used in combination of the above technique by using the programming language code as follows:

```
smoothen = function(x) {
    x1 <− round2(x)
    x1[is.na(x)] <− 0
    m <− max(ceiling(x1))
    y1 <− as.numeric(smooth(ifelse(x1>=1, 1, 0), kind=“3”))
    y2 <− as.numeric(smooth(ifelse(x1>=1, 1, 0), kind=“3RSS”))
    y <− pmax(y1,y2)
    if (m >= 2) {
      for (i in 2:m) {
        y <− y + as.numeric(smooth(ifelse(x1>=i, 1, 0), kind=“3R”))
      }
    }
    y[is.na(x)] <− NA
    y
  }
```

### Minutes to Number of Employees

Finally, forecast minutes may be translated into number of employees. This may be done based on a ceiling function, such as the following ceiling function:

```
    forecastemployees =
MAX(CEILING(
      ([forecastsmoothed] *[Anomaly])/([Target Utilizationtime]*60.0),
      CEILING][advancebookingmins]/([Target Utilizationtime]*60.0))
  ))
```

where,
forecast_{smoothed}=forecasted appointment minutes after adjustment;
Anomaly=anomaly computed earlier;
Target Utilizationₜᵢₘₑ=Utilization targeted based on count vs. time; and
advancebookingmins=the already booked minutes for that time period

### Holidays and Work Timings

The forecasts may also be adjusted, by a computing device, based on a consideration of holidays and associated work timings. Two types of holidays may be handled:
1. Fixed day holidays such as July 4^{th}; and
2. Moving holidays such as Thanksgiving

Moving holidays may be handled using the employee scheduled minutes time series with at least one 364-day seasonality. Since there are no schedules set on holidays, the idea is that if the employee forecast shows a low number, most likely it is due to non-working hours of the Center or Center holidays. These factors may be considered to produce a final forecast, as follows:

```
forecast_{final} = IF [fcastemps] < (60*0.3)
  THEN 0
  ELSE [forecast_{smoothed}]
  END
```

where,
fcastemps=forecasted employee minutes obtained earlier; and
forecastsmoothed=smoothed forecast obtained earlier.

That is, if the forecasted employee minutes do not show significant work timings for that hour (e.g., less than 20 minutes), the forecasted value may be adjusted to zero.

In one aspect, the forecast of appointment minutes and the forecast of available employee minutes may be adjusted, by a computing device, based on holiday data. The holiday(s) may have an impact on surrounding days of the holiday(s) affecting the appointment minutes. The holiday may also impact the specific day of the holiday for employee minutes as no employees may need to be scheduled that day due to it being a holiday.

### Arriving at Employee Shifts Based on Forecasted Numbers

Once the number of employees to be scheduled for each hour of the day is determined, it may still be a tedious task for a manager to decide the shift for each employee. A shift represents the time when an employee starts and ends his or her day. The shifts need to be determined so that they add up to the number of forecasted appointment minutes each hour of the day. The number of appointment minutes may be translated into a whole number by dividing the appointment minutes by 60 and applying a ceiling function as known in the art. In accordance with one aspect, this may be done using a Generalized Task assignment algorithm solved using linear programming (e.g., Rsymphony package in R). The example code below provides one example solution for selecting the shifts that add up to the forecast.

The following steps may be performed:
1. Generate a binary matrix of past shifts that any employee worked in that job in the last 6 months.
2. Shifts[i,j]=1 if shift i has an employee working at half-hour j for 0<=j<=48. For example 24 hours divided into 48 parts in the matrix. Index 1 means 00:30 while 2 means 01:00 hrs.
3. Using linear programming choose shifts from this matrix in such a way that
   a. their sum for each hour adds to less than or equal to the forecasted number at that hour.
   b. The total number of shifts are less than or equal to a given maximum.
      #shifts2 is a binary matrix, and column 49 represents length of the shift in hours.
      #obj represents the objective which is the length of each shift
      #mat represents transformed shift matrix except the last column j=49
      #rhs represents the right hand side of each equation in linear programming set
      #dir represents one of <=, =or >=
      #schedule represents the forecast by hour for a single day

```
obj <− shifts2[,49]
  mat <− t(shifts2[,c(−49)])
  rhs <− c(schedule[1:48], sum(schedule[1:48]), maxproviders)
  dir <− c(rep(“<=”, 48), “<=”, “<=”)
  sol <− Rsymphony_solve_LP(obj, mat, dir, rhs, bounds = NULL,
  types = “B”,
    max = T, verbosity = −2, time_limit = 60,
    node_limit = −1, gap_limit = −1, first_feasible = T,
    write_lp = FALSE, write_mps = FALSE)
shiftsol <− shifts2[which(sol$solution==1),1:48,drop=F]
```

This returns a matrix of shifts that add up to the forecast for the day, each row representing a shift of an employee, 1 if he or she is working, 0 otherwise. Note that it is possible that some forecasts may not generate any solution while others may not add precisely to hourly numbers in the forecast.

The shifts thus returned can be stored for each day in a relational database. The relational database may be stored in a memory device. In an aspect, the memory device may comprise, for example, a random access memory (RAM) 925 and/or a read only memory (ROM) 930 of FIG. 28. Each of the shifts may be associated with a job, a date the respective shift applies to, a start time for the shift and an end time for the shift.

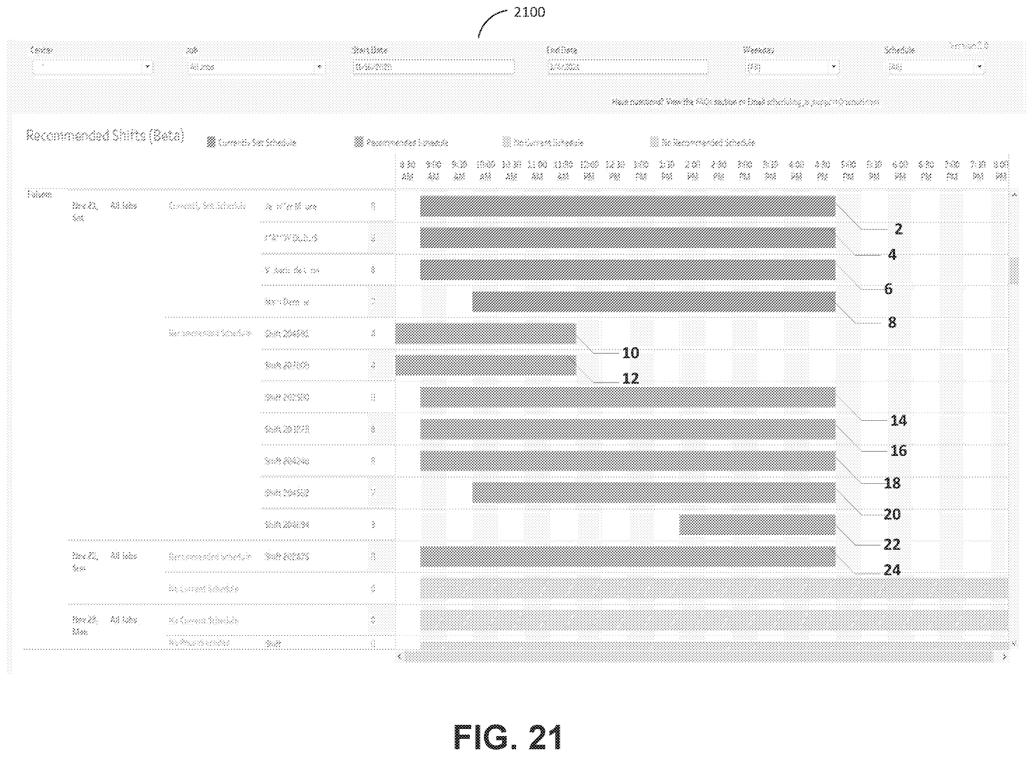

FIG. 21 illustrates an exemplary shift visualization dashboard 2100 for a given day and job, showing the start and end times of each of various shifts. As shown in FIG. 21, currently set schedules 2, 4, 6 and 8 may indicate the hours that corresponding employees (e.g., Jennifer Moore, a fictitious person) are scheduled for a job(s). The currently set schedules 2, 4, 6 and 8 may be assigned manually by a user such as, for example, a manager supervising the job(s)). As an example in FIG. 21, a manager may manually assign currently set schedule 2 for an employee. The currently set schedule 2 may indicate that an employee is scheduled for a job (e.g., a hair stylist job) for 8 hours from 8:30 AM—4:30 PM. Additionally, the dashboard 2100 indicates recommended schedules 10, 12, 14, 16, 18, 20, 22 and 24 for various shifts (e.g., Shift 204591, Shift 207009, Shift 202590, etc.). The recommended schedules 10, 12, 14, 16, 18, 20, 22 and 24 may be generated in an automated manner by a computing device utilizing the Generalized Task assignment algorithm described above. One or more of the scheduled employees may be assigned to one or more of the shifts by the computing device. In this regard, as an alternative to utilizing the currently set schedules 10, 12, 14, 16, 18, 20, 22 and 24, a computing device utilizing the Generalized Task assignment algorithm may recommend the schedules 10, 12, 14, 16, 18, 20, 22 and 24, as optimized schedules, for employees to work particular shifts. The recommended schedules 10, 12, 14, 16, 18, 20, 22 and 24 may provide better recommendations for setting shifts for a given day, which a manager could then use to assign shifts to specific employees.

### Schedule Generation/Visualization

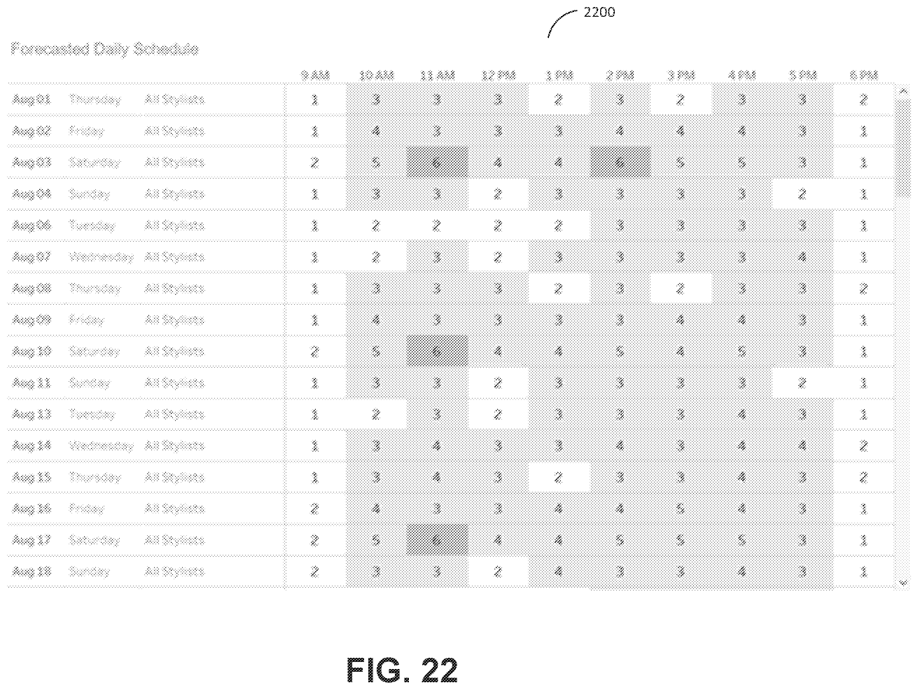

In step 160, based on the initial raw forecasts, as modified by the various weighting factors and transformations described above, a schedule may be generated, for example by a computing device, indicating a number of employees needed to satisfy the forecast of future appointment minutes. FIG. 22 illustrates one example of a dashboard 2200 tabular view that shows an example forecasted daily schedule. As shown, for each day, and each hourly time period within the day, a number of required employees is provided. The dashboard may also provide a comparison of actual values to forecasted values.

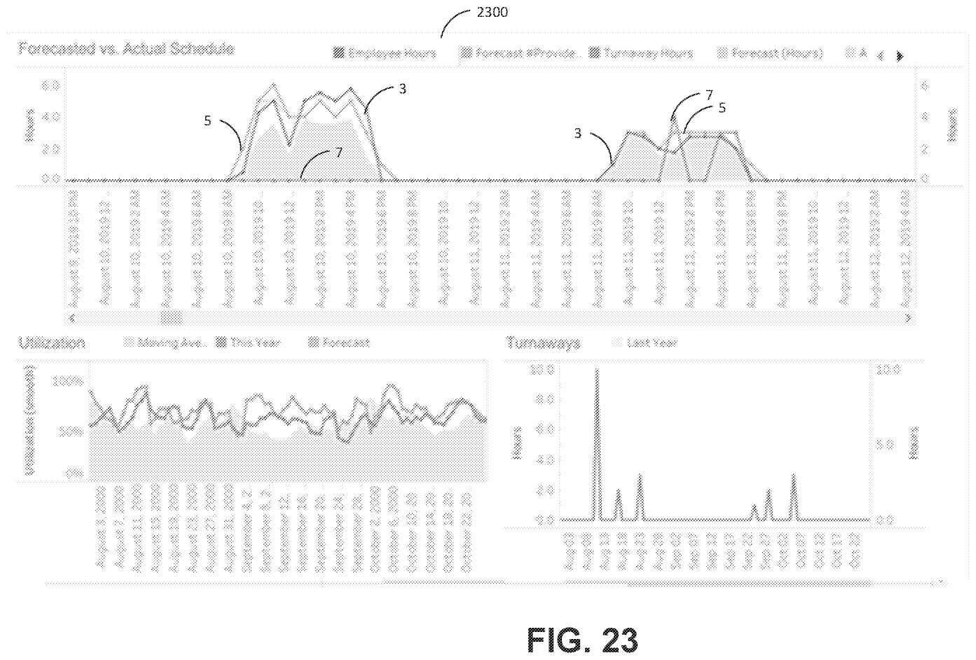

The dashboard may also allow to compare the actual vs. forecasted employee schedule in the past for a quick comparison of the performance. FIG. 23 shows an example dashboard 2300 view overlaying actual values in the past against forecasted values. As shown, at least two metrics that may be tracked:
1. Utilization (forecasted vs. actual); and
2. Turnaways (actual).

The shaded area of the “Forecasted vs. Actual Schedule” graph shows appointments while one line 3 denotes actual employee hours. Another line 5 indicates forecasted employee hours dropped against the line 7 indicating turnaway hours.

FIG. 23 shows an anomaly adjusted forecast, for example in dashboard 2300.

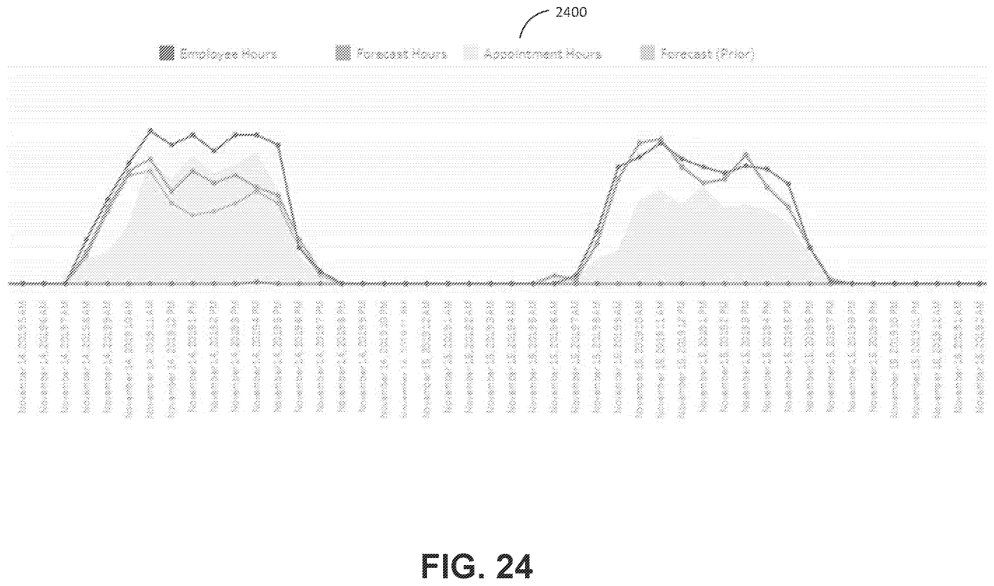

The information provided by the dashboard views 2200, 2300, and 2400 illustrated in FIGS. 22, 23, and 24 can help a user to track two metrics (i.e., important metrics) to ensure optimal results:
1. Consistent and higher utilization; and
2. Reduced turnaway guests.

By optimizing these two metrics, a Center may ensure it has staffed its operation adequately, successfully catering to demand while not overstaffing.

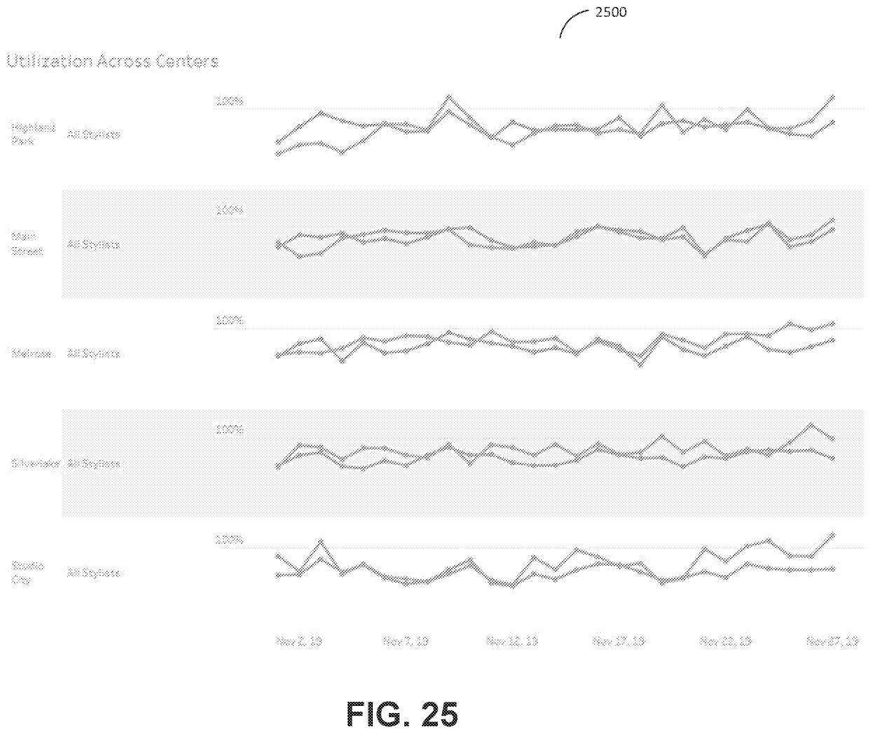

Another view that may be provided via the dashboard 2500 is illustrated in FIG. 25. This example view shows utilization for multiple Centers that may be generating forecasts at their respective locations. This view helps to provide a quick overview of utilization across multiple centers over time. One line denotes the utilization following the forecast, while the other line denotes the actual utilization (hour based).

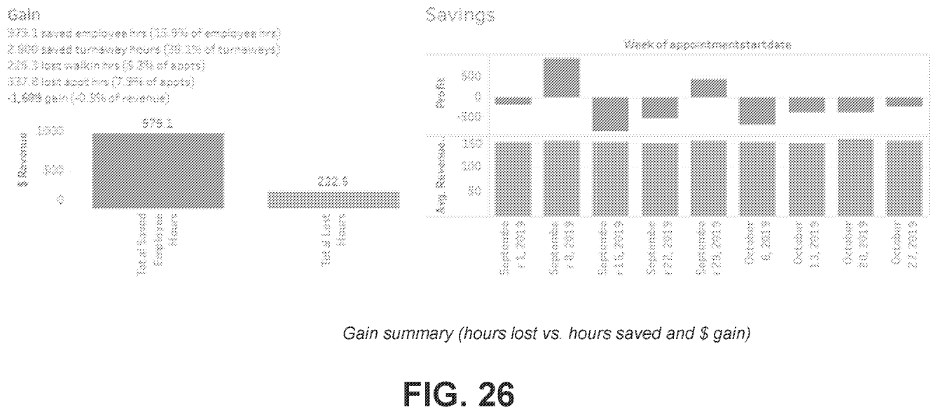

FIG. 26 illustrates an example of revenue gain visualization, depicting saved employee hours versus lost appointment hours and translation to monetary gain.

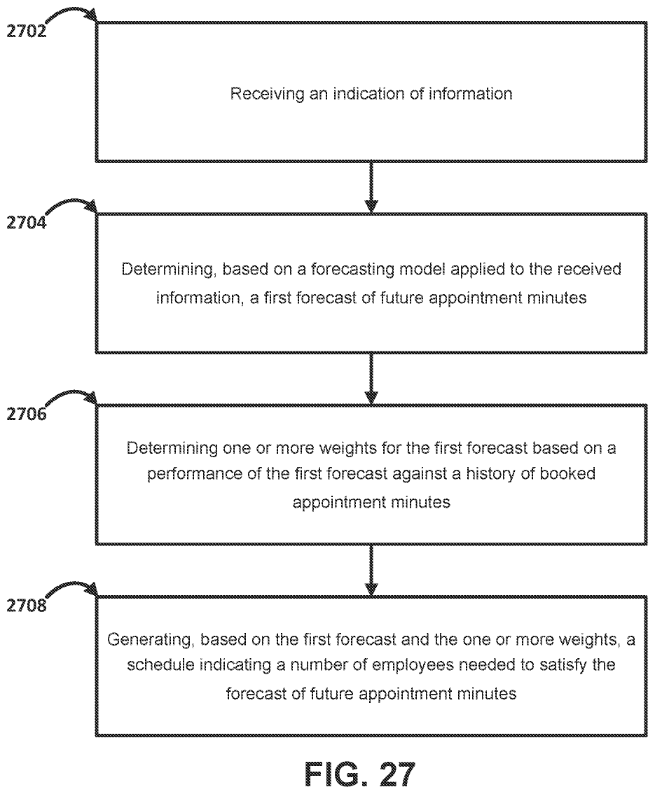

FIG. 27 shows an example method for generating an employee schedule based on forecasts in accordance with the aspects described above. At step 2702, an apparatus (e.g., computing device 900) may receive an indication of information. The received information may be indicative of: a number of booked appointment minutes and a count of booked appointments; a number of scheduled employee minutes and a count of scheduled employees; and a number of employee break minutes. The received information may also include any other suitable information such as, for example, one or more items of information indicated in Table 1. The received indication of information may be received from one or more Centers.

At step 2704, an apparatus (e.g., a computing device 900) may determine a first forecast of future appointment minutes. The determination may be based on a forecasting model applied to the received information. At step 2706, an apparatus (e.g., computing device 900) may determine one or more weights for the first forecast based on a performance of the first forecast against a history of booked appointment minutes.

At step 2708, an apparatus (e.g., computing device 900) may generate a schedule indicating a number of employees needed to satisfy the forecast of future appointment minutes. The generated schedule may be based on the first forecast and the one or more weights for the first forecast.

FIG. 28 is a block diagram of an exemplary computing device on which, for example, the methods described herein may be implemented. Computing device 900 may be controlled primarily by computer readable instructions, which may be in the form of software, wherever, or by whatever means such software is stored or accessed. Such computer readable instructions may be executed within central processing unit (CPU) 910 to cause computing device 900 to do work. In many known workstations and personal computers, central processing unit 910 is implemented by a single-chip CPU called a microprocessor. In other machines, the central processing unit 900 may comprise multiple processors. Coprocessor 915 is an optional processor, distinct from main CPU 910, that performs additional functions or assists CPU 910.

In operation, CPU 910 fetches, decodes, and executes instructions, and transfers information to and from other resources via the computer's main data-transfer path, system bus 905. Such a system bus connects the components in computing device 900 and defines the medium for data exchange. System bus 905 typically includes data lines for sending data, address lines for sending addresses, and control lines for sending interrupts and for operating the system bus. An example of such a system bus 905 is the PCI (Peripheral Component Interconnect) bus.

Memory devices coupled to system bus 905 may include RAM 925 and ROM 930. Such memories include circuitry that allows information to be stored and retrieved. ROMs 930 generally contain stored data that cannot easily be modified. Data stored in RAM 925 can be read or changed by CPU 910 or other hardware devices. Access to RAM 925 and/or ROM 930 may be controlled by memory controller 920. Memory controller 920 may provide an address translation function that translates virtual addresses into physical addresses as instructions are executed. Memory controller 920 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing device 900 may contain peripherals controller 935 responsible for communicating instructions from CPU 910 to peripherals, such as, printer 940, keyboard 945, mouse 950, and disk drive 955.

Display 965, which is controlled by display controller 963, is used to display visual output generated by computing device 900. Such visual output may include text, graphics, animated graphics, and video. Display 965 may be implemented with a CRT-based video display, an LCD-based flat-panel display, gas plasma-based flat-panel display, or a touch-panel. Display controller 963 includes electronic components required to generate a video signal that is sent to display 965.

Further, computing device 900 may contain network adaptor 970 that may be used to connect computing device 900 to an external communications network 960. Communications network 960 may provide computer users with means of communicating and transferring information electronically. Communications network 960 also may include but is not necessarily limited to fixed-wire local area networks (LANs), wireless LANs, fixed wire wide-area-networks (WANs), wireless WANs, fixed wire extranets, wireless extranets, fixed-wire intranets, wireless intranets, fixed wire and wireless peer-to-peer networks, fixed wire and wireless virtual private networks, the Internet, and the wireless Internet. Additionally, communications network 960 may provide distributed processing, which involves several computers and the sharing of workloads or cooperative efforts in performing a task. It will be appreciated that the network connections shown are exemplary and that other means of establishing a communications link between the computers may be used.

It is understood that any or all of the systems, methods and processes described herein may be embodied in the form of computer executable instructions (i.e., program code) stored on a computer-readable storage medium which instructions, when executed by a machine, such as a computer, perform and/or implement the systems, methods and processes described herein. Specifically, any of the steps, operations or functions described above may be implemented in the form of such computer executable instructions. Computer readable storage media include all non-transitory forms of storage, including both volatile and nonvolatile, removable and non-removable media implemented in any method or technology for storage of information. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other non-transitory medium which can be used to store the desired information and which can be accessed by a computer. As used herein, the term computer readable storage medium does not comprise signals.

Changes may be made to the above-described aspects of the invention without departing from the broad inventive concept thereof. This invention is not limited to the particular aspects disclosed but is intended to cover all modifications which are in the spirit and scope of the invention as defined by the appended claims.

1. A method of generating a schedule of employees needed to satisfy one or more appointments, comprising:
receiving information indicative of:
a number of booked appointment minutes and a count of booked appointments,
wherein the booked appointment minutes comprise total service minutes in a time period;
a number of scheduled employee minutes and a count of scheduled employees; and
a number of employee break minutes;
determining, based on a forecasting model applied to the received information, a first forecast of future appointment minutes;
determining one or more weights for the first forecast based on a performance of the first forecast against a history of booked appointment minutes; and
generating, based on the first forecast and the one or more weights, a schedule indicating a number of employees needed to satisfy the forecast of future appointment minutes.

2. The method of claim 1, further comprising:
determining, based on the forecasting model applied to the received information, a second forecast of future available employee minutes; and
determining one or more weights for the second forecast based on a performance of the second forecast against a history of the number of scheduled employee minutes.

3. The method of claim 1, wherein the forecasting model comprises at least one of a Seasonal and Trend Decomposition using Loess forecast (STLF) model or a Vector Autoregression (VAR) model.

4. The method of claim 2, wherein the generating the schedule is further based on the second forecast and the one or more weights for the second forecast.

5. The method of claim 1, wherein the received information further comprises information indicative of minutes associated with turning away one or more individuals for providing at least one service based on non-availability of one or more of the employees.

6. The method of claim 1, wherein receiving the information comprises receiving at least a subset of the information from one or more centers associated with facilitating performance of at least one service, associated with the one or more appointments, by one or more of the employees.

7. The method of claim 1, wherein determining the one or more weights comprises determining a target utilization, and wherein generating the schedule comprises adjusting the forecast of future appointment minutes by the target utilization.

8. The method of claim 7, wherein the determined target utilization is based in part on a quantity of the employees available to satisfy the one or more appointments.

9. The method of claim 1, further comprising:
adjusting the forecast of future appointment minutes based on determining an anomaly associated with at least a subset of the received information.

10. The method of claim 9, wherein the anomaly comprises an outlier associated with the future appointment minutes.

11. The method of claim 1, further comprising:
determining, based on the schedule, one or more employee shifts configured to satisfy one or more requirements of the schedule.

12. An apparatus comprising:
one or more processors; and
at least one memory storing instructions, that when executed by the one or more processors, cause the apparatus to:
receive information indicative of:
a number of booked appointment minutes and a count of booked appointments,
wherein the booked appointment minutes comprise total service minutes in a time period;
a number of scheduled employee minutes and a count of scheduled employees; and
a number of employee break minutes;
determine, based on a forecasting model applied to the received information, a first forecast of future appointment minutes;
determine one or more weights for the first forecast based on a performance of the first forecast against a history of booked appointment minutes; and
generate, based on the first forecast and the one or more weights, a schedule indicating a number of employees needed to satisfy the forecast of future appointment minutes.

13. The apparatus of claim 12, wherein the instructions, when executed by the one or more processors, further causes the apparatus to:
determine, based on the forecasting model applied to the received information, a second forecast of future available employee minutes; and
determine one or more weights for the second forecast based on a performance of the second forecast against a history of the number of scheduled employee minutes.

14. The apparatus of claim 12, wherein the forecasting model comprises at least one of a Seasonal and Trend Decomposition using Loess forecast (STLF) model or a Vector Autoregression (VAR) model.

15. The apparatus of claim 13, wherein the instructions, when executed by the one or more processors, further causes the apparatus to:
generate the schedule based on the second forecast and the one or more weights for the second forecast.

16. The apparatus of claim 12, wherein the received information further comprises information indicative of minutes associated with turning away one or more individuals for providing at least one service based on non-availability of one or more of the employees.

17. The apparatus of claim 12, wherein the instructions, when executed by the one or more processors, further causes the apparatus to:
adjust the forecast of future appointment minutes based on a determined target utilization.

18. A computer program product comprising a computer readable storage medium having instructions encoded thereon which, when executed by a processor, cause:
receiving information indicative of:
a number of booked appointment minutes and a count of booked appointments,
wherein the booked appointment minutes comprise total service minutes in a time period;
a number of scheduled employee minutes and a count of scheduled employees; and
a number of employee break minutes;
determining, based on a forecasting model applied to the received information, a first forecast of future appointment minutes;
determining one or more weights for the first forecast based on a performance of the first forecast against a history of booked appointment minutes; and
generating, based on the first forecast and the one or more weights, a schedule indicating a number of employees needed to satisfy the forecast of future appointment minutes.

19. The computer program product of claim 18, wherein the computer readable storage medium having instructions encoded thereon which, when executed by the processor, further causes:
determining, based on the forecasting model applied to the received information, a second forecast of future available employee minutes; and
determining one or more weights for the second forecast based on a performance of the second forecast against a history of the number of scheduled employee minutes.

20. The computer program product of claim 18, wherein the forecasting model comprises at least one of a Seasonal and Trend Decomposition using Loess forecast (STLF) model or a Vector Autoregression (VAR) model.

21. The computer program product of claim 18, wherein determining the first forecast of future appointment minutes is further based on analyzing one or more appointment minutes booked in advance.

22. The computer program product of claim 19, wherein the computer readable storage medium having instructions encoded thereon which, when executed by the processor, further causes:
adjusting the first forecast based on analyzing the history of booked appointment minutes associated with one or more past holidays; and
adjusting the second forecast based on analyzing the history of the number of scheduled employee minutes associated with the one or more past holidays.

23. The computer program product of claim 19, wherein the computer readable storage medium having instructions encoded thereon which, when executed by the processor, further causes:
generating one or more employee shifts based on an associated hourly forecast and one or more employee shifts utilized in the past.
